(19) United States
(12) Patent Application Publication
(10) Pub. No.: US 2015/0030996 A1
(43) Pub. Date: Jan. 29, 2015

(54) HDZ Golden Smile Gold Inlay/Onlay PFM optional Tooth Tattoo

(71) Applicant: Reynaldo Rodriguez Hernandez, San Antonio, TX (US)

(72) Inventor: Reynaldo Rodriguez Hernandez, San Antonio, TX (US)

(21) Appl. No.: 13/923,616

(22) Filed: Jul. 24, 2013

(51) Int. Cl. A61C 13/08; A61C 5/08; A61C 13/09

(52) U.S. Cl. CPC A61C 13/082; A61C 13/09; A61C 5/08
USPC 433/203.1

(57) ABSTRACT

Hernandez Dental Studio presents the new paradigm for pure gold brilliance. Cut gold fees in half or more using this revolutionary dual alloy method in ceramo-metal dental ceramics. By the incorporating of matching CTE's of all its parts, gold is back in dentistry, and all purities of gold are now inexpensive as in the past and will continue for all generations afterward. A gold tooth can now be designed artistically with a complete facial coverage of a gold crown, a open face (round border) gold crown, a ¾ gold crown or a multitude of styles and shapes and drawings on a beautiful 96% Au. 2% Pt. HDZ Golden Smile. Dental implants, ceramic bridges or a single PFM can create pure gold awesomeness. And this method also can also create a dual alloy combination on a facial of a PFM, like a silver arrow through a gold heart.

This is for Application 67/704,864 filed Sept. 24, 2012, Attorney Docket No. 504462156

### FIELD OF THE INVENTION

The Present invention relates to a method of the manufacturing of a gold inlay/onlay PFM; a dual alloy gold laminate veneer medical device as a dental prosthodontic appliance for a Porcelain Fused to Metal (PFM) restoration that can be applied as a segment or segments on a PFM, a PFM Bridge or Fixed PFM Implant.

### BACKGROUND OF THE INVENTION

It is known in the art of the dental laboratory of technology a false tooth made completely of gold can replace the anatomical space on a front anterior tooth that some consider a symbol for wealth. A gold full facial onlay PFM, gold laminate veneer, the ¾ inlay PFM or an open face design, are the most popular today's gold PFM prostheses. This method of manufacturing the gold inlay/onlay to a PFM will reduce the cost by using a dual ceramo-metal technique with a minimal amount of gold by fusing two different alloys together during the opaque and porcelain application in a porcelain oven. Many designs and shapes like monograms, drawings on gold, logos are the make of the tooth-tattoo fusing the least amount of the precious metal. Though unlike gold plated or solder, this method for the manufacturing has not an acrylic facing nor electro-plated as in the past and the gold inlay/onlay PFM is strictly cosmetic and is not a crown or cap manufactured for the purpose to implement a biocompatible prostheses for patients with allergic reactions to certain metals or their elements. No special liquids are required, coping inner-face is not included and the gold inlay/onlay is external to dental porcelain and custom contoured to a metal Framework for any PFM structure. The dental medical device, materials and procedures are as follows and currently used with Good Manufacturing Practices and ADA approved alloys and ceramic systems in modern fixed dental laboratory technology around the world. To make an anterior crown with a ¾ gold inlay PFM used in this example is an alloy with content of 96% Au. and 2% Pt. (there are a multitude of gold alloy options available), and a standard base metal with 76% Ni. and 14% Cr. (with a multitude of base metal, stainless steel, or another noble or high noble dental alloy options available) as an inexpensive PFM coping substructure.

This method requires all materials to have matching Coefficient of Thermal Expansion (CTE) in each alloy and porcelain ceramic system and also a second working model for the gold inlay/onlay second alloy. Let's begin with the first working models completed for tooth #9.

### SUMMARY OF THE INVENTION

According to the first aspects of the invention there is provided a method of manufacturing a gold inlay/onlay PFM compromising the steps of: (a) imaging a tooth structure with a reference to occlusion, adjacent teeth and gum tissue to provide three dimensional computer graphic models or using a conventional impression to create gypsum hydrocal and die stone models; (b) wax to full contour the maxillary central tooth shape functional and aesthetic and sprue, invest and burn out wax; (c) then cast an ADA approved base metal (stainless steel) crown with an alloy of matching Coefficient of Thermal Expansion (CTE) to the gold and porcelain to be used in the manufacturing; (d) metal finish to a functional and aesthetic full non precious prosthesis. Though it's now ready (unpolished) to deliver as a completed stainless steel crown, it's also ready to be transformed to a 23 kt HDZ Golden Smile inlay/onlay with the most beautiful and most glorious gold used in today's fixed ceramo-metal dental prosthetics. The example shown here is a gold ¾ open face HDZ gold inlay for the PFM: any shape or desired design for gold to be fused, by vitrification of the PFM external surface and the gold inlay's flange and opaque with the use of dentin porcelain and its color components and it's axial anatomical contours to the base or alternate metal coping substructure. The procedures continue as; (e) cut back the finished base metal crown (which can also be done in wax if confident) the facial and incisal area where the inlay/onlay will be placed, that will support the ¾ gold inlay to maintain exact position during baking of opaque and porcelain with preferably just enough room for a thin ¾ wax pattern design approximately 0.4-0.7 mm thick. This step we will visit later in more detail including the necessary “free way space”; (f) using a cutting disc like a Dedeco Double-Side Disc #5203, cut back approximately 0.4-0.7 mm on the facial, the incisal edge, the mesio-facial, the disto-facial and lingual incisal area where the ¾ gold inlay will be placed (for gold full facial or open face onlay a preparation with a butt shoulder margin is recommended for improved aesthetics and to eliminate bulky emergence profile). Cut back the lingual where there is room occlusally, approximately 0.4 mm, for the opaque and porcelain where a variable metal lingual may be necessary for porcelain support (no more than 2 mm of unsupported porcelain can be allowed). Cut back to a lingual finish line on the base metal away from where the margin of the gold inlay flange (border) will be and also away from direct centric occlusion of any opposing teeth. The lingual surface will transition from the metal lingual collar or metal occlusal (variable) to porcelain in the middle section to the gold lingual incisal edge minimal gold margin. Cutback also using carbide burs (#6 and/or #8 round) where the inlay will replaced its original contour. A slight beveled finish line is best for a smooth and aesthetic transition of all the ceramo-metal margins, proximal surfaces and the inlay's flange and opaque areas. Once the cutback is complete, a working model for the ¾ gold inlay (use this technique and method also for an open face or full facial gold onlay) is made; (g) Using a lubricant or separator (mineral oil) paint a coat on the model only and not on the metal. Place the cutback metal crown back on the working model. Block out undercuts around the working die of the crown and make a putty matrix using a lab-putty like Coltene #8805 (that will facilitate in the fabrication of the ¾ gold inlay second working model to duplicate the dimensions and wax pattern exact position) and place and adapt putty to the metal crown on the model and the model's adjacent anterior dentition. After the putty has set a few minutes, remove it carefully without tearing and pour a new die stone working model. Once this model is set, trim and you now have a new working model. It's not necessary to separate the die for the ¾ inlay wax up, since the mesial and distal contacts will be made of porcelain and can be easily adjusted. Mark the inlay's margins and use a sealer (cyanoacrylate) around the new model's ¾ inlay area and blow off excess with air pressure and let dry. (h) Now wax the ¾ inlay (or the design desired keeping in mind the procedure is the same for a Tooth Tattoo). When wax pattern is complete, (i) sprue, invest and cast into gold in conventional casting procedures. After casting, divest, sandblast and metal finish to the new model it was waxed on till it's seated and finished completely.

(j) Now it's time to create a Free-Way Space between the two alloys but mostly cutback the base metal since it is very thick in most areas to make room for a opaque filament to be applied in between both alloys and around ¾ inlay's flange (border) and over the base metal coping. Cut back the base metal crown again a second time making room for opaque under and surrounding the ¾ gold inlay, using the cutting discs and carbide burs but keeping some index stops of at least 5 tiny untouched contact points of the two alloys at the incisal and facial area on the base metal under the ¾ gold inlay that will provide support and exact positioning of the two alloys during the opaque and porcelain application. The base metal cut back should appear to have a grid or corn rows at first using a cutting disc, then additional free-way space is created with a #6 carbide bur that will allow room for opaque when both alloys are joined together. After the free-way space is completed, cut back all the facial, distal, interproximal and lingual surfaces where porcelain will be applied excluding the previously cut back ¾ inlay area on the base metal coping. The margin and flange (border) areas of the gold inlay is 0.4-0.7 mm thick. Condition the alloys bonding surfaces with carbides and green carbondium stones all around both alloys where the opaque (or onlay, or complete facial coverage) is to be placed and all the way around the beveled margins of the gold inlay flange before degassing. Degas to oxidize both alloys by manufacturers recommendations separately. (k) Once both alloys are cool, place a thin coat of opaque to exterior of the base metal coping and the under-face and flange of the ¾ gold inlay and connect the alloys together in the exact position (like an opaque sandwich) and lay carefully on a soft firing tray and bake the first opaque layer. Margins of the inlay will be embossed, extended with an over lapping flange opaqued to the base metal coping. This will create the first bonding of both alloys together. The Free-Way Space between the crown and the ¾ gold inlay are cut rows and gaps on the base metal under the gold inlay. The space of approximately 0.2-0.4 mm is filled with opaque in between the two alloys and porcelain around the flange margins of the inlay/onlay and exterior surfaces. Once the opaque shade is completed, dentin porcelain is applied completely covering facial, lingual, mesial, and distal on the dual alloy PFM then fired (baked) under vacuum in the porcelain oven.

Then contour onto the first model to a functional and aesthetic crown and remove excess porcelain off the ¾ inlay external surfaces, glaze and polish.

### OBJECTS OF THE INVENTION

It is a first object of the present invention to provide a method of manufacturing a gold crown more economically with high end gold materials creating a dual alloy PFM supported by an alternate inexpensive alloy by fusing together in a porcelain oven with opaque and porcelain with exact CTE of its alloys and ceramic system creating the dual alloy prostheses. Many other alloys may be used as the coping such as palladium or different white noble or high noble gold ceramo-metal dental alloys but stainless steel is used only in this example which is the most cost effective dental alloy and most economical on this restoration.

Many patients desire a gold front tooth. The gold laminate veneer provides an alternate method to create an exquisite gold jewel, a symbol for wealth. The amount and cost of high end gold is greatly reduced by 50-90% compared to the previous method using only one alloy, and this method will also help preserve our natural precious resources. The procurement of this advanced medical device evolution is the future for gold in dentistry. Materials for this new method of the present invention in conventional dental labs are already evident. The gold laminate veneer's assortment of the Full Facial and Open Face Onlay PFM, the gold Tooth Tattoo, the ¾ Inlay PFM, can be manufactured by customized waxing and then casting two different alloys before fusing both together an affordable HDZ Golden Smile in a style for a beautiful gold artistic personal expression. The present invention of the dual alloy PFM is joined with adequate strength by the vitrification of the opaque and porcelain firings in an oven and now a highly pure cosmetic gold crown is made viable. As opaque and porcelain shrinks during each bake, the two alloys bond together for a final bond strength of 82-97 MPa. The more surface area the inlay/onlay has when joined to the base metal, the better the bond, as long as there is positively no centric occlusal direct force in any area of a ceramo-metal junction. The possibility of fusing of two alloys together in dentistry is here today and now only available at Hernandez Dental Studio in San Antonio, the future leads to the possibilities of the development of a pure gold to fuse to Zirconia and also a CAD/CAM program software for implementing the dual alloy concept. Gold attachments including intricate artistic drawings like a leaf carving with a rose in gold.

The ¾ Gold Inlay/Olay or Tooth Tattoo helps eliminates the waste of our resources of precious metals that are presently costly to the patients and dentists and this method is a unique improvement in the field.

### BRIEF DESCRIPTION OF THE DRAWINGS

Other objects and features of the present invention will be better understood by way of the following detailed description of the preferred embodiment with reference to the appended drawings in which:

FIG. 1 is a perspective facial view of a central tooth crown with the gold ¾ inlay PFM gold laminate veneer.

FIG. 2 is a cross-sectional view similar to FIG. 1

FIG. 3 is a perspective view of the lingual of gold inlay/onlay PFM.

FIG. 4 is a perspective incisal view of a gold ¾ inlay and open face onlay PFM.

FIG. 5 is a perspective mesial view of a gold ¾ inlay PFM.

FIG. 6 is a cross-sectional mesial view of FIG. 5, a gold ¾ inlay PFM.

FIG. 7 is a perspective mesial lingual view of a gold ¾ inlay PFM.

FIG. 8 is a perspective facial view of gold ¾ inlay separated with the base metal prior to opaque application and porcelain application.

FIG. 9 is a perspective distal view of a gold full facial and gold open face onlay PFM gold laminate veneer.

FIG. 10 is a perspective facial view of a gold full facial onlay PFM.

FIG. 11 is a perspective facial view of an gold open face onlay PFM.

FIG. 12 is a perspective view of the base metal coping inner-face for the full facial and open face onlay PFM with the gold butt shoulder facial margin.

### DETAILED DESCRIPTION OF THE PREFERRED EMBODIMENT

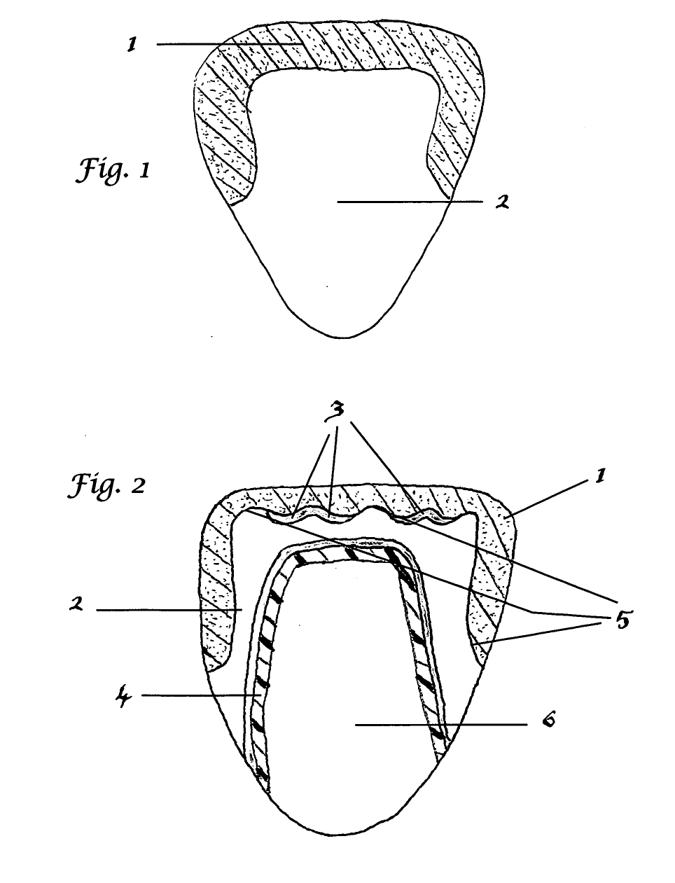

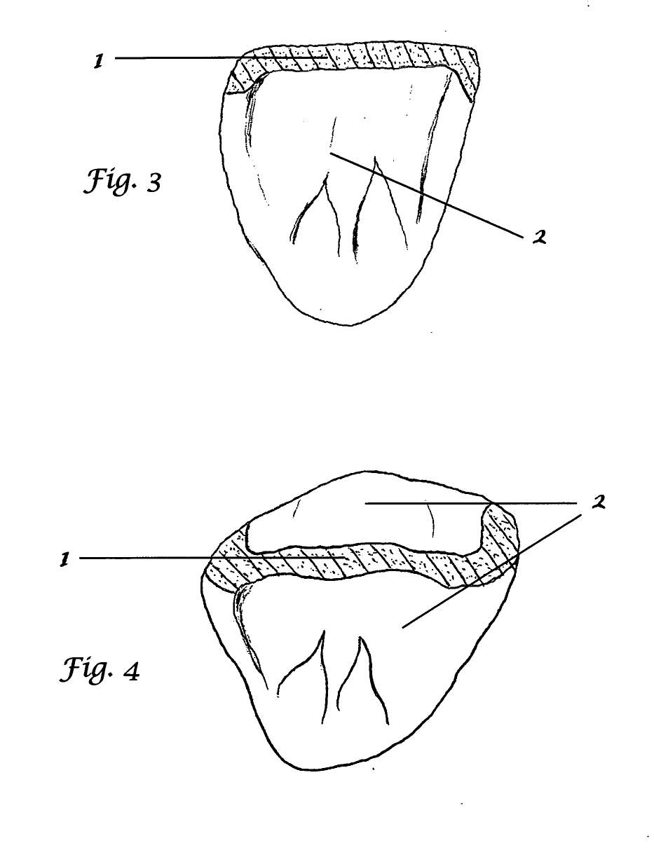

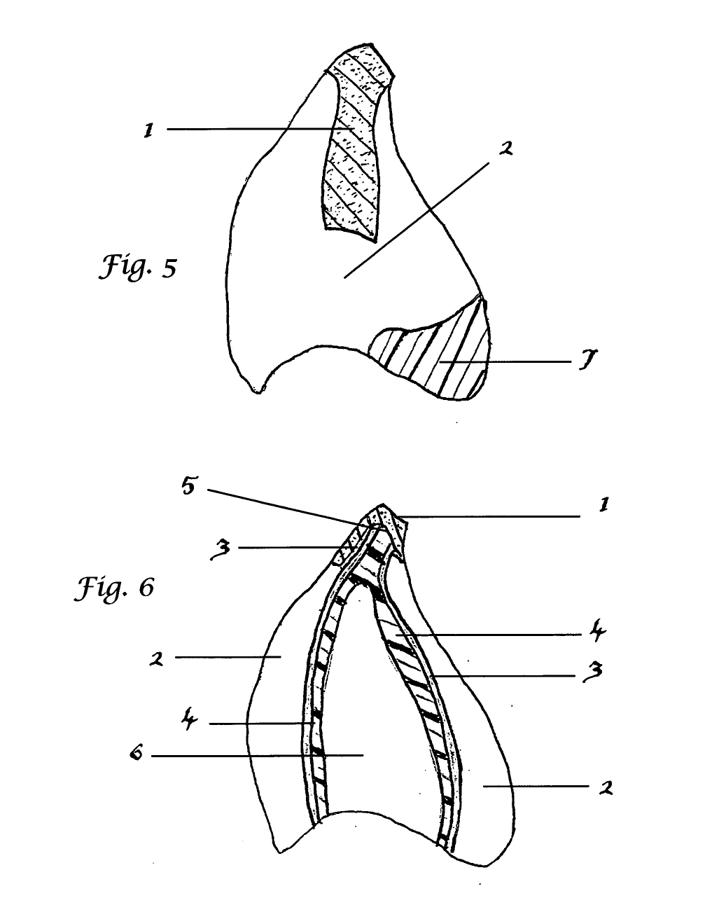

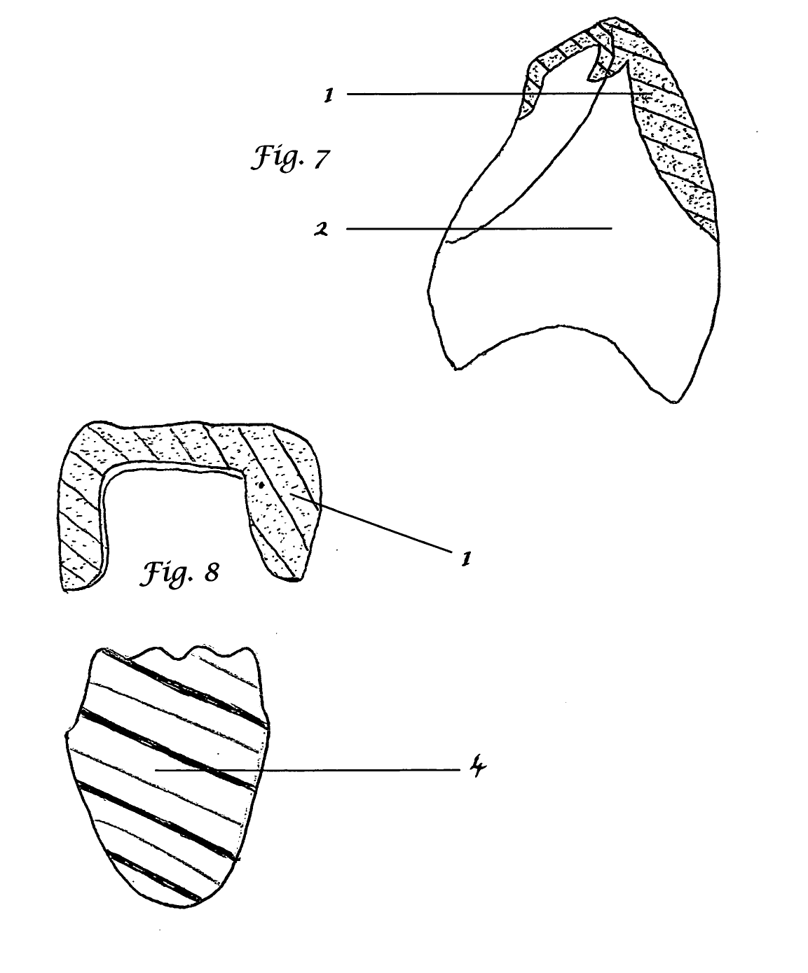

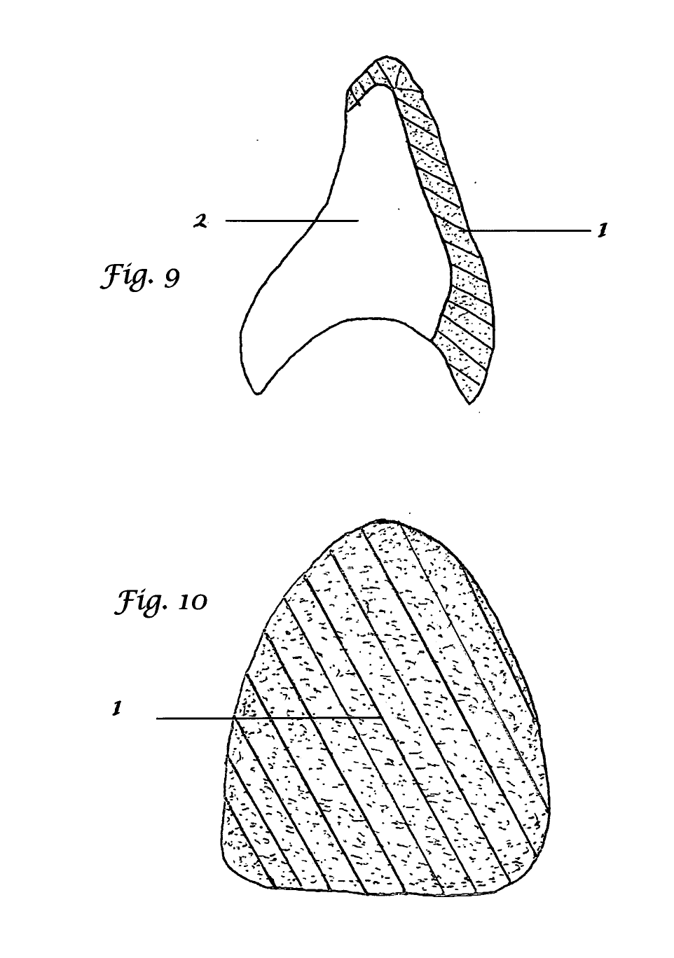

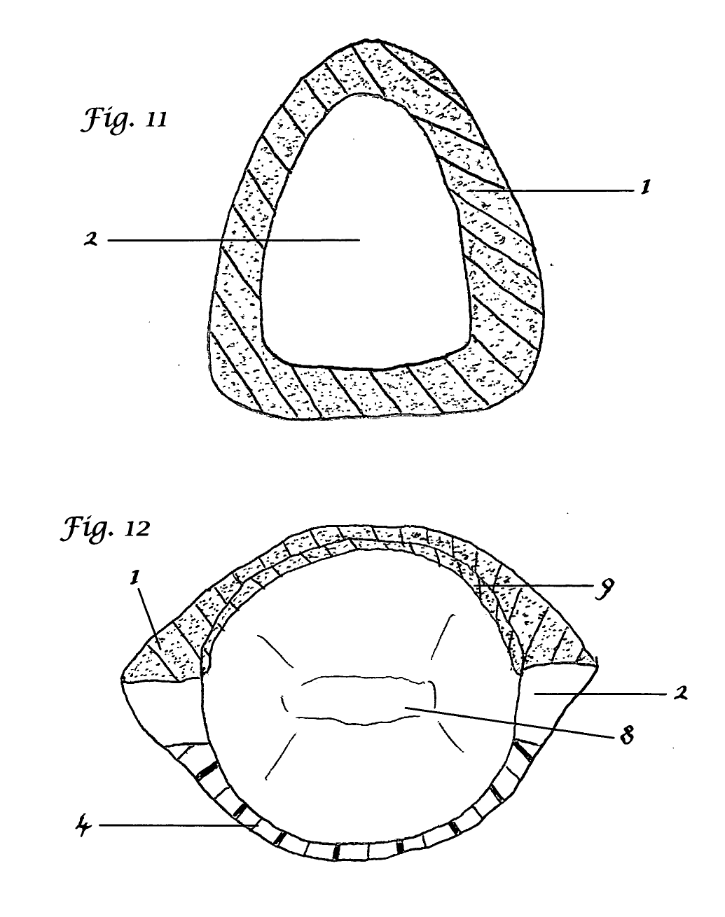

As illustrated in FIG. 1, the facial of a gold ¾ inlay 1 as known in the art is fused to a PFM 2 is a fixed prostheses. A yellow high noble gold is a beautiful dental ceramo-metal of choice and porcelain is fused all together with a base metal alloy. As illustrated in FIG. 2, the elements in the cross sectional within the device exhibits free way spaces 3 that are filled with opaque 3 between the gold inlay and the fully opaque base metal 4 surrounded by porcelain. The index stops 5 support the exact positioning of the dual alloy PFM component on a prepped abutment 6. As shown in FIG. 3, the lingual has a minimal amount of gold 2 and the ceramo-metal margin transitions to a porcelain on the PFM 2 with a variable porcelain or metal lingual external surface. As illustrated in FIG. 4, the incisal edge reveals the gold ¾ inlay 1 on the PFM 2. As illustrated on FIG. 5, the mesial exterior surface incorporates the gold ¾ inlay 1 on the PFM 2 with the variable porcelain or base metal external lingual collar surface 7. As shown in FIG. 6, the cross-sectional view reveals the index stops 5 between the gold inlay and the opaque base metal 4 in the free way space 3 that is the initial bonding agent during the first bake. As illustrated in FIG. 7, the mesial lingual contour has an anatomical tooth morphology that is aesthetic with the gold ¾ inlay 1 on a PFM 2 with a variable porcelain or metal lingual exterior surface. As shown in FIG. 8, a gold ¾ inlay 1 and a base metal 4 coping before the opaque and porcelain applications. As illustrated in FIG. 9, the distal exhibit's a little more gold is necessary for a gold open face onlay 1 on a PFM 2 than the ¾ design. As illustrated in FIG. 10, the gold full facial onlay 1 PFM gold laminate veneer requires the most gold of the three variations, however extremely less than the past method using an entire substructure of gold. As illustrated in FIG. 11, a gold open face onlay 1 on a PFM 2 is a facial coverage of gold including the facial margin as, FIG. 10, on a PFM. As shown in FIG. 12, a gingival view reveals at the inner-face 8 and inside the metal base 4 coping a open face or full facial inlay/onlay 1 on a PFM 2 is most aesthetic with a facial butt shoulder 9 margin prep for an ideal emergence profile with a gold to tooth abutment contact on the facial like the known porcelain butt shoulder margin.

### REFERENCE

Dental Laboratory Technology: Department of the Air Force, 1990

Metal Ceramic Principles and Methods of Makoto Yamamoto,

Quintessence Publishing Company, Chicago, 1985

Dental laboratory technology. (Washington D.C. Department of the Air Force), 1982

Dental Laboratory Procedures—Fixed Crown and Bridge, Volume 1, Robert M. Morrow, D.D.S., F.A.C.D.,F.I.C.D., Kenneth D. Rudd, D.D.S., F.A.C.D., F.I.C.D., Harold F. Eissman, D.D.S., F.A.C.D., C.V. Mosby Company 1980

Dental Laboratory Technology. (Washington D.C. Department of the Air Force, 1975

DENTAL LABORATORY Technology—FIXED RESTORATIVE TECHNIQUES

Operative Crown and Bridge, Henry V. Murray, B.S., D.D.S., Troy B. Sluder, D.D.S., M.S.

University of North Carolina, 1972

Ney Crown and Bridge Manual: Crown Contour, J. M. Ney, Hartford, Conn., 1972

What is claimed is:

1. A dental medical device is the HDZ Golden Smile gold inlay/onlay PFM, optional gold Tooth Tattoo, an inexpensive method for manufacturing a dual alloy gold inlay/onlay PFM comprising:
the steps of imaging a tooth structure with a reference to occlusion, adjacent teeth and gum tissue to provide three dimensional computer graphic models or using a conventional impression to create gypsum hydrocal and die stone models for the manufacturing of a dual ceramo-metal PFM, an elegant prosthetic containing a yellow high noble gold alloy joined together to a different base metal or alternative alloy and dental porcelain:
a inlay/onlay PFM can be applied as a segment or segments on a PFM crown, a PFM Bridge or Fixed PFM Implants. Gold (96% Au. 2% Pt.) of this content and many yellow high noble gold alloys used for ceramo-metal purpose for PFM fabrication in the dental laboratory industry can be utilized with this method to include an alternate coping substructure inexpensively and apply gold to the exterior of porcelain and the secondary dental alloy coping substructure with porcelain fused to metal or including the combination of and when the substructure is stainless steel or one of many noble or high noble gold alloys with a lower purity content for and as a substructure alloy only with matching materials with relative Coefficient of Thermal Expansion (CTE) to all its parts:
a gold Inlay/Onlay PFM optional Tooth Tattoo is exclusively cosmetic. Gold is fused external to the opaque and porcelain application. Bond strength of the combined alloys by use of opaque and porcelain is (82-97 MPa) and adequate in a biometric force analysis for a PFM dental appliance. WARNING! NEVER place any ceramo-metal margin in the opposing occlusion's direct contact.

2. A dual ceramo-metal gold inlay/onlay PFM makes gold affordable, reaching a high level of luxury of any tooth color shade, custom or modified in its surrounding ceramic components including gold images, while the method preserves our natural precious metal resources.

3. A dual ceramo-metal gold inlay/onlay PFM contains a yellow high noble gold and may include other ceramo-metal gold purity variables on each of its alloy parts fused external to opaque and porcelain in the art of dental laboratory technology.
